(19) United States
(12) Patent Application Publication
(10) Pub. No.: US 2010/0265187 A1
(43) Pub. Date: Oct. 21, 2010

(54) SIGNAL ROUTING IN AN OLED STRUCTURE THAT INCLUDES A TOUCH ACTUATED SENSOR CONFIGURATION

(76) Inventors: Shih Chang Chang, Cupertino, CA (US); Steven Porter Hotelling, Cupertino, CA (US)

Correspondence Address: APPLE c/o MOFO LA, 555 WEST FIFTH STREET SUITE 3500, SUITE 200, LOS ANGELES, CA, 90013-1024, US

(21) Appl. No.: 12/426,906

(22) Filed: Apr. 20, 2009

(51) Int. Cl. G06F 3/041

(52) U.S. Cl. 345/173

(57) ABSTRACT

Briefly, in accordance with one embodiment, signal routing for a touch sensor configuration may occur via a transistor driver integrated with an OLED structure.

### FIELD

This disclosure relates generally to signal routing for an organic light emitting diode (OLED) structure that includes a touch actuated sensor configuration.

### BACKGROUND

Many types of input devices are available for performing operations in a computing system, such as buttons or keys, mice, trackballs, joysticks, touch sensor panels, touch screens, or the like. Touch screens may come in a variety of forms, such as a touch sensor panel, which may include a clear or transparent panel with a touch-sensitive surface and a display device, which may include a display positioned partially or fully behind a touch panel so that a touch-sensitive surface may cover at least a portion of a viewable area of the display device. Touch screens generally allow a user to perform various functions by touching (e.g., physical contact) a touch sensor panel or by near-field proximity to it. In general, a computing system may register a touch event and may be capable of performing one or more actions based at least in part on registration of the touch event.

Touch screens, or devices that may incorporate, or be compatible with, touch screen technology, seem to be increasingly popular. Their popularity with consumers may be partly attributable to their relative ease or versatility of operation, as well as, their declining price. In addition, touch screens may also be increasingly popular due, in part, to their generally decreasing overall size, their reliability, or their robustness. A corollary to these characteristics may be that, from a manufacturer's perspective, costs associated with producing devices including touch screens, or producing devices including touch screens with characteristics which are believed to be desirable for consumers, have decreased or become less onerous. Accordingly, there generally is a desire to continue to develop approaches or techniques believed to be desirable for consumers or end-users in terms of cost, performance or a combination thereof.

### BRIEF DESCRIPTION OF THE DRAWINGS

FIG. 1 is a plan view illustrating an example of a hand held device embodiment.

FIG. 2 is a plan view illustrating the example hand held device of embodiment of FIG. 1 in greater detail.

FIG. 3 is a process flow diagram illustrating an example process embodiment for making an organic light emitting diode (OLED) structure embodiment that includes a touch sensor configuration embodiment.

FIG. 4 is a side view illustrating an example of a partially fabricated OLED structure embodiment.

FIG. 5 is a side view illustrating an example of a fabricated OLED structure embodiment.

FIG. 6 is a side view illustrating an example transistor driver structure embodiment integrated with an example OLED structure embodiment in a module or integrated circuit embodiment.

FIG. 7 is a plan view illustrating a bottom surface of a substrate for an example OLED structure embodiment that includes a touch sensor configuration embodiment.

FIG. 8 is a block diagram illustrating an example computing system embodiment.

FIG. 9 is a schematic diagram illustrating various example device embodiments.

### DETAILED DESCRIPTION

In the following description of embodiments, reference is made to the accompanying drawings which form a part hereof, and in which it is shown by way of illustration specific embodiments of claimed subject matter. It is to be understood that other embodiments may be used, for example, changes or alterations, such as structural changes, may be made. All embodiments, changes or alterations are not departures from or as to scope with respect to intended claimed subject matter.

This disclosure relates generally to a transistor driver structure embodiment integrated with or in direct physical contact with an organic light emitting diode (OLED) structure embodiment in a module or integrated circuit (IC) embodiment. For one embodiment at least, however, the OLED structure embodiment includes a passive touch actuated sensor configuration embodiment. Therefore, signals for the touch actuated sensor configuration embodiment may be routed through the transistor driver structure for further processing off module or IC or to another component or within the module or IC. In this context, a touch actuated sensor configuration may refer to a configuration of touch sensors, including a surface, in which touch sensors of the configuration are responsive to direct physical contact with (e.g., touching) or close proximity to the surface of the configuration or a portion thereof. It is noted also that the terms touch actuated sensor configuration, touch activated sensor configuration, touch sensor panel and touch sensor configuration may be used interchangeably throughout this specification. Likewise, in this context, a passive touch actuated sensor configuration may refer to a touch actuated sensor configuration in which it is not required that additional energy, regardless of form, be supplied to the overall touch sensor configuration or system for touch sensors of the configuration to be responsive.

In an example embodiment, a touch actuated sensor configuration embodiment may include an array of touch sensors integrated within an OLED structure so as to electrically connect to an array of OLED pixels. Here, the detection of a touch event by one or more touch sensors may be sensed by sense circuitry and processed or otherwise interpreted. The interpreted touch data may result in a processor or other circuit electrically activating pixels of the array to change the display, as described in more detail below. OLED structures may provide potential advantages over possible alternative display technologies, depending at least in part on the particular application. For example, OLED structures typically do not employ light valves or similar technology.

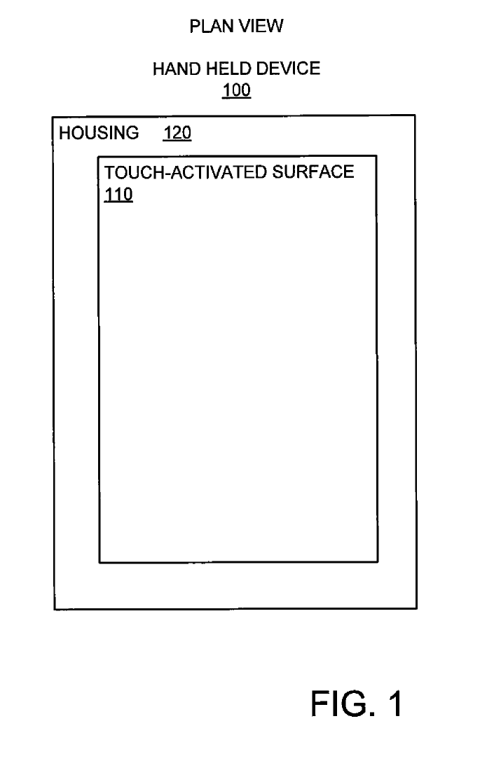

Turning to the figures, FIG. 1 is a plan view illustrating an example of a hand held device embodiment 100. It is noted that claimed subject matter is not limited in scope to a hand held device. This is simply one example embodiment. Rather, claimed subject matter may be employed in connection with any one of a host of possible devices, including a computing system, a mobile phone, a personal digital assistant, or a set top box, just to name a few examples. However, for purposes of illustration and without limitation, in this example embodiment a plan view of hand held device embodiment 100 is shown, including a touch sensitive or touch actuated or touch-activated surface 110 and a housing 120.

A touch surface, such as surface 110, may, in this context, sometimes also be referred to as a touch sensitive surface or a touch activated surface. In general, a touch sensitive surface may include a clear or transparent substrate with a configuration of sensors typically, but not necessarily, in contact with the substrate. A touch actuated sensor configuration may also be positioned in front of a display so that a touch sensitive surface covers at least a portion of a viewable area of the display. As indicated previously, for this particular embodiment, and as shall be explained in greater detail, an OLED structure embodiment may be employed here to provide the viewable area. The arrangement of this particular embodiment, for example, may allow a user to make selections or move a cursor, such as by touching a portion of a touch sensitive surface positioned in front of a display with an object (e.g., a finger), or by placing the object in close proximity to the surface. In general, a touch sensitive surface may recognize and electronically register a touch or other direct physical contact or a near touch with the touch sensitive surface via touch sensors connected to processing components or circuitry within the hand held device, for example, capable of processing such actions, gestures or surface contacts. Therefore, a computing system including circuitry or processors, for example, may interpret the registered touches or near touches and perform an action based at least in part on processing by the computing system. Of course, as used herein, the term computing system may refer to a specific or special purpose computing system. For example, in this instance, a computing system to process touch events or the like is described.

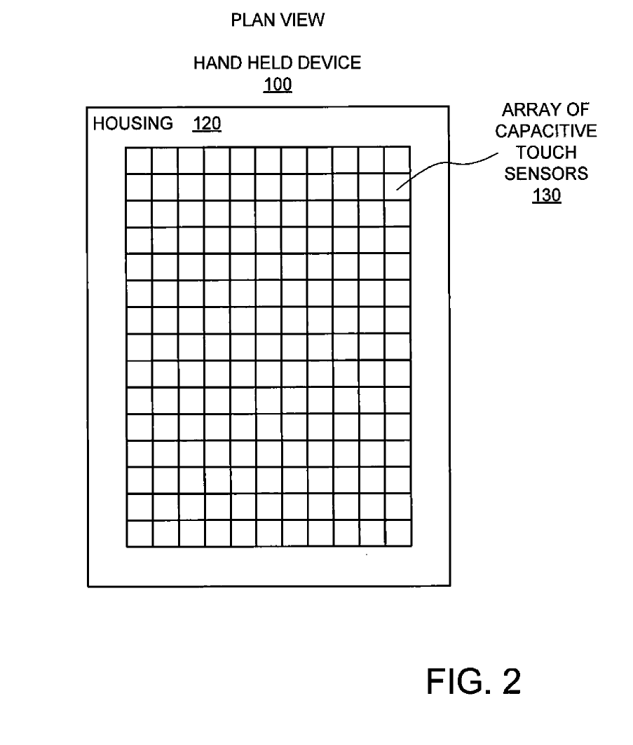

FIG. 2 is a plan view illustrating the example hand held device embodiment of FIG. 1 in greater detail. This particular embodiment, without limitation, illustrates hand held device embodiment 100 including an array of capacitive touch sensors 130 under a surface of a display (e.g., touch glass). For this particular embodiment, as suggested previously, an array of capacitive touch sensors may form a touch sensitive surface over at least a portion of a viewable area of a display screen. Again, in this particular embodiment, the viewable area may be provided by an OLED structure embodiment that shall be described in more detail later. It should be understood that this general illustration of an array of capacitive touch sensors 130, and hand held device 100 is merely a schematic depiction to aid the understanding of one of ordinary skill in the art. Hand held device 100, housing 120, and array of capacitive touch sensors 130, for example, are not illustrated to scale—particularly capacitive touch sensors 130. Furthermore, while a possible configuration using a particular sensing technology, here capacitive, is illustrated schematically, claimed subject matter is not limited to employing only capacitive touch sensor technology. Accordingly, many different configurations, touch sensing technologies, or various manufacturing processes may be employed without any departure from or with respect to claimed subject matter scope. It is, therefore, understood that any or all configurations, technologies, or processes, or the like, are intended to fall within the scope of claimed subject matter. What is provided herein are simply illustrative examples thereof.

As suggested previously, many different sensing approaches or technologies may be used in conjunction with a touch actuated sensor configuration embodiment included within an OLED structure embodiment. For example, a touch actuated sensor configuration embodiment may utilize, but is not limited to, touch actuated sensing technologies which may employ resistive, optical, surface acoustic, or capacitive technology, or any combinations thereof, just to a name a few. While for particular embodiments disclosed herein a capacitive touch actuated sensor configuration is illustrated in detail, it is of course understood that any or all other approaches or techniques may also or alternatively be utilized in connection with an OLED structure embodiment that includes a touch sensor configuration embodiment.

Referring again to FIG. 2, a touch actuated sensor configuration may utilize capacitive sense technology. For this particular embodiment, a configuration of touch sensors having respective touch sensing locations may be formed. For example, one or more electrical structures may include a pattern of conductive traces (e.g., drive and sense lines) arranged in a manner so as to sense a change in capacitance which may be occasioned by an object, such as a finger, touching, contacting or hovering over a touch sensitive surface of a configuration that may include an array of touch sensors at particular touch points or touch locations. For example, an array of touch sensors may be formed from a pattern of conductive traces. As an object approaches a touch sensitive surface, one or more touch sensors of the configuration at particular touch sensing points or locations may experience a change in capacitance occasioned by proximity to the object. By detecting a change in capacitance at one or more of the touch sensing points or locations, and by noting the particular location or position associated with the change in capacitance, a sensing circuit may detect and register one or more touch events, such as, for example, an image of touch. After being detected and registered, touch events may be processed or otherwise used to at least in part control operation of an electronic device, such as for one or more operations of hand held device 100, by way of example. It is noted that throughout this specification with respect to the operation of a touch sensor the terms sensing points, sensing locations, touch point, touch locations or the like are used interchangeably.

Although a variety of particular embodiments are possible, configurations or arrangements for use in a touch actuated sensor configuration may include “self” capacitive or “mutual” capacitive configurations. In a “self” capacitive configuration, for example, capacitance may be measured relative to some reference, such as a ground or ground plane. In a “mutual” capacitive configuration, capacitance between drive and sense lines may be measured. Accordingly, “self” or “mutual” capacitive configurations may have similar or common aspects with respect to structural or electrical arrangements employed as well as dissimilar aspects with respect to structural or electrical arrangements employed, as described immediately below.

In a “mutual” capacitance sensing arrangement or configuration embodiment, for example, sensing locations may be formed by a crossing of patterned conductors formed from spatially separated conductive lines or traces. In one particular embodiment, conductive traces may lie in substantially parallel planes, the conductive traces of a particular plane being referred to here as being substantially co-planar, the substantially parallel planes in this particular embodiment otherwise being relatively close in proximity. Furthermore, substantially co-planar conductive traces may be oriented to be substantially parallel. However, conductive traces from different planes may be oriented so as to be substantially perpendicular in direction. That is, substantially co-planar conductive traces lying in a first plane having a first orientation or direction may be substantially perpendicular to substantially co-planar conductive traces lying in a second or in another plane having a second orientation or direction.

For example, in one embodiment, drive lines may be formed on a first layer in a first direction and sensing lines may be formed on a second layer in a second direction substantially perpendicular to the first direction such that drive and sense lines may “cross” one another at various touch sensing locations, albeit the drive lines being on a different layer of the configuration than the sense lines. It is noted here that for the purposes of this patent application, the term “on” is not intended to necessarily refer to directly on. For example, a second layer may be formed on a first layer without the two layers being in direct physical contact. Thus, there may, continuing with the example, be additional layers or other material between these first and second layers. Notwithstanding the examples provided above, it should be understood that other non-perpendicular (e.g., non-orthogonal) orientations of the traces in the two planes are also possible.

A variety of other arrangements or configuration embodiments are also possible to provide a capacitance sensing arrangement or configuration, although claimed subject matter is not intended to be limited to any particular one. For example, conductive traces may be formed on different sides of a substrate. Conductive traces that may include shapes such as diamonds that cross in the manner discussed above may also be formed on one side of a substrate with an insulating separation, such as a dielectric, separating the traces at different crossover locations. Conductive traces may also be formed on different substrates with the substrates being oriented so that the conductive traces lie in different substantially parallel planes while being on different layers. Employing a separation between drive and sense lines, in this particular embodiment, may result in capacitive coupling or capacitively coupled nodes between sense and drive lines at common locations or crossing locations that otherwise lie in different substantially parallel planes, as described above. In such an embodiment, these capacitively coupled locations may form an array of touch sensors.

In another example, an array of touch sensors may be formed from conductive traces and shapes such as patches and columns formed on the same layer on the same side of a substrate in a single-sided ITO (SITO) configuration. In a SITO configuration, the drive lines may be formed from a row of patches of conductive material that may be connected through conductive traces and metal in the border areas of a panel, for example. The sense lines may be formed as columns or connected patches of conductive material. Other SITO configurations are also possible. Therefore, claimed subject matter is not limited in scope to this particular description. In some SITO embodiments, electrical activation or stimulation of a drive line may result in mutual capacitance between adjacent drive and sense line patches or columns, for example. A finger or other object may result in a change in this mutual capacitance that may be detected by sensing circuits. Of course, these are merely example embodiments, and claimed subject matter is not intended to be limited in scope to these or any other particular embodiments.

A “self” capacitive configuration embodiment, in contrast, may measure capacitance relative to a reference ground plane. Also, a self capacitive embodiment typically employs an array or other arrangement of conductive patches or pads, such as Indium Tin Oxide (ITO) pads or patches. It is noted, without limitation, that ground plane may be formed on the back side of a substrate, on the same side as an array of conductive pads or patches, but separated from the patches or pads, or on a separate substrate. We likewise note that claimed subject matter is not limited in scope to ITO. Rather, any transparent conductive material, such as, for example, ZTO, may likewise be employed or any combinations thereof. In a self-capacitance touch sensor configuration embodiment, self-capacitance of a sensor relative to the reference ground may be changed due at least in part to the presence of an object, such as a finger. In some self-capacitance embodiments, self-capacitance of conductive column traces, for example, be sensed independently, and self-capacitance of conductive row traces may also be sensed independently.

In addition to different sensing approaches that may be used in conjunction with a touch actuated sensor configuration embodiment, there may also be different arrangements for a touch actuated sensor configuration embodiment. Some of these arrangements may depend at least in part on the manner or the processes utilized to form a touch actuated sensor configuration or a touch sensitive surface. For example, different arrangements may vary as to sensor or sensing point location as well as relative orientation of a touch surface to one or more of the touch sensors or sensing points. However, any or all arrangements are intended to be within the scope of claimed subject matter and, therefore, may be utilized with a host of possible touch actuated sensor configuration embodiments.

An aspect of an embodiment in which a transistor driver structure is integrated with an OLED structure relates to a process for manufacture or fabrication. For example, a transistor driver embodiment may be fabricated on one side of a substrate and an OLED structure embodiment may be fabricated on one side of another substrate in separate processes. In this embodiment, as described in more detail below, the OLED structure may be fabricated to include a touch sensor configuration. The transistor driver structure embodiment and the OLED structure embodiment may be combined into a single module or IC so that the transistor driver structure embodiment and the OLED structure embodiment contact one another. Furthermore, in such an embodiment, within the OLED structure embodiment, one or more respective touch sensors of the touch actuated sensor configuration may be electrically connected to the OLED structure, although claimed subject matter is not limited in scope in this respect. Various approaches are available and intended to be included within claimed subject matter so that the transistor driver structure embodiment and the OLED structure embodiment may be physically, and in some embodiments, electrically connected, as described in more detail below.

Again, it is noted here that for this particular embodiment of an integrated module or integrated circuit (IC), for example, the transistor driver structure embodiment and the OLED structure embodiment may be fabricated by separate processes. Furthermore, in the particular embodiment, after fabrication, the transistor driver structure embodiment and the OLED structure embodiment may be physically, and in some embodiments, electrically connected. In one particular embodiment, for example, metallized spacers on the OLED structure may be employed to form electrical connections. In particular, electrical connections for a touch sensor configuration embodiment within the OLED structure may be routed from the OLED structure to the transistor driver structure via one or more spacers. From the transistor driver structure, for example, electrical connections to the touch sensor configuration embodiment may either be directed off module or IC or to another component within the module or IC so that further processing of the signals may take place. It is noted that a variety of fabrication techniques for integrating the transistor driver structure and the OLED structure may be employed and claimed subject matter is not limited in scope to any particular technique. As examples, heat may be applied, pressure may be applied, radiation may be applied, or any combination thereof. Likewise, a curable paste that may include a polymer or an adhesive may be utilized.

One potential advantage of employing separate processes to fabricate the transistor driver structure embodiment and the OLED structure embodiment may be that OLEDs tend to be sensitive to high temperature or high pressure processes. On the other hand, high temperature or pressure processes typically may be employed in the fabrication of a transistor driver structure. Thus, employing separate fabrication processes may permit fabrication in a manner that is less likely to damage the OLED structure embodiment. Furthermore, as described in more detail below, for the OLED structure embodiment, a touch sensor configuration embodiment may be fabricated before fabrication involving OLE material to form a display, for example. This also reduces likelihood of damage to the OLED structure since fabrication of a touch sensor configuration embodiment also may involve the use of high temperatures or pressures. Likewise, a process for curing the contact or integration of an OLED structure with a transistor driver structure in a module or IC typically involves less temperature or less pressure than the high temperature or pressure processes just mentioned, again reducing the likelihood of damage to an OLED structure. Yet another potential advantage of this particular embodiment may be the ability to increase module or IC yield. For example, the transistor driver structure embodiment and the OLED structure embodiment may be tested after fabrication, but before being integrated. This may produce higher yields than otherwise might result.

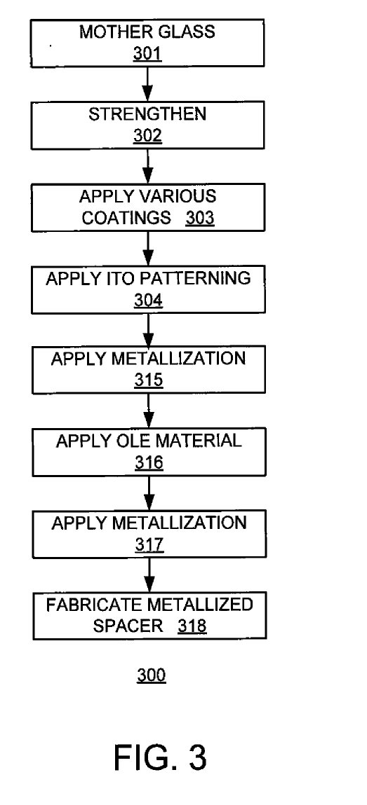

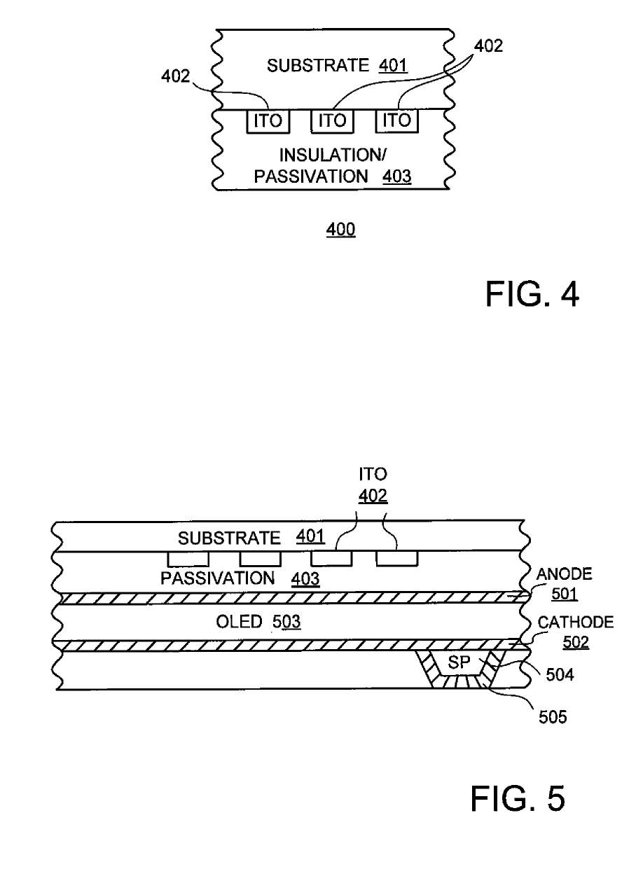

FIG. 3 is a flow chart or flow diagram illustrating an example process embodiment 300 for producing an OLED structure embodiment that includes a touch sensor configuration embodiment. In the discussion below, reference is also made to a schematic diagram of an embodiment 400 as illustrated by FIG. 4. It should be noted that the process flow embodiments of FIG. 3 are provided as examples or illustrations. Therefore, it is further noted that some blocks may be omitted, additional blocks may be added to the flow, alternative blocks may be employed, or completely different fabrication processes involving a flow of different blocks may be utilized. Any and all other embodiments are intended to be included within the scope of claimed subject matter.

As suggested previously, in some particular OLED structure embodiments, a touch sensor configuration embodiment is included within the OLED structure. Furthermore, in this example embodiment, a touch sensor configuration embodiment is fabricated before fabrication involving the OLE material. Again, such an approach it is believed has an advantage in that damage to the OLED structure may be less likely during fabrication. OLED structures are typically sensitive to high temperature or pressure processes. Therefore, this approach permits high temperature or pressure processes to be employed in a manner so that the portion of the OLED structure including the OLE material should not be significantly affected.

For this embodiment, beginning at block 301, a substrate, such as a “motherglass,” may be prepared for processing, from which a number of individual substrates may be produced, although it should be understood that cingulated substrates may also be used. Reference now is made here to FIG. 4, which is a cross-sectional side view diagram of an embodiment 400. Therefore, this configuration embodiment includes motherglass 401, as shown. Typical materials which may be used as a substrate include materials having properties such as being relatively inert to subsequent processing, not being opaque to radiation, or providing electrical insulation. For example, suitable materials for a substantially transparent substrate may include glass, plastic, ceramic, metallic, organic or inorganic materials, or any combination thereof. Likewise, at least some of these example materials may also be flexible or rigid.

Chemical strengthening may be performed on the “motherglass,” as shown by block 302, which may involve employing a nitric acid bath at a high heat, resulting in compressive forces or stresses at the surface layer of the glass and tensile stresses at the inside core of the glass. Various coatings may be employed, illustrated at block 303, such as an anti-glare coating, which may include particle-embedded silicon dioxide, an anti-reflective coating, a black mask coating on selected regions, or an application of an overcoat layer. These various coating or layers may be applied using a variety of techniques, which may include printing, roller coating, or sputtering followed by etching of unwanted areas, as non-limiting examples. Of course, in some embodiments, such coatings may be omitted.

A clear or transparent overcoat may be formed, which may include a clear or transparent polymer curable with ultraviolet (UV) light. This coating may smooth over black mask areas, for example, in some embodiments. Likewise, this coating may in some embodiments form a substantially planar surface for subsequent Indium Tin Oxide (ITO) sputtering or conductive material (e.g., metal) patterning at block 304. As suggested, ITO or other conductive material may be sputtered, or otherwise applied or deposited, and patterned, illustrated in FIG. 4 by 402. Depending at least in part on the particular configuration, conductive lines or conductive pads or patches may be patterned. An insulation or passivation layer may be formed over the patterned ITO or other conductive material, illustrated in FIG. 4 by 403. An insulator, for example, may have dielectric properties. In some embodiments, layer 403 may also be formed so that a second layer of ITO may be later formed, although, of course, claimed subject matter is not limited in scope in this respect. Of course, in an embodiment employing single layer ITO (SITO), ITO patches or pads may form touch sensors.

It is noted that a host of manufacturing processes or operations may be involved in fabrication of a particular touch actuated sensor configuration embodiment, such as to fabricate additional layers, for example, that have not been mentioned specifically here. The example process embodiment illustrated in FIG. 3 and the example touch sensing configuration embodiment illustrated in FIG. 4 represent merely one approach. In FIG. 4, a side view is provided to depict a simplified high-level touch sensor configuration embodiment. As suggested previously, for example, sensors or sensor locations may be formed on a single side of a single substrate, on opposite sides of a single substrate, or on one side of two different substrates. Furthermore, single ITO (SITO) or double ITO (DITO) layers of patterned ITO may be employed to form touch sensor or touch sensor locations. Again, any or all arrangements are intended to be within the scope of claimed subject matter and, therefore, may be utilized with a host of possible touch actuated sensor configuration embodiments.

Depending at least in part on a particular application and a particular embodiment, the number of touch sensors or their configuration may vary considerably. For example, these may vary based, at least in part, on a desired resolution or sensitivity for a particular embodiment. Similarly, these may also vary depending at least in part on a desired transparency. Likewise, an array of touch sensors may be arranged in a Cartesian or rectangular coordinate system. As one example embodiment, drive lines may be formed as horizontal rows, while the sense lines may be formed as vertical columns (or vice versa), thus forming a plurality of touch sensors that may be considered as having distinct x and y coordinates. This approach is depicted, albeit simplified, in example hand held device 100 at FIG. 2. In another approach, an array of ITO pads or patches may be arranged in a Cartesian or rectangular coordinate system. Likewise, a polar coordinate system embodiment may be employed. For example, conductive traces may be arrayed as a plurality of concentric circles with another set of conductive traces being radially extending lines. Conductive patches or pads may be similarly arranged, thus forming a plurality of touch sensors that may be considered as having distinct radius and angle coordinates. Furthermore, touch sensor configurations may also be formed so that sensors are arranged in any number of dimensions and orientations, including but not limited to, diagonal, concentric circle, three-dimensional or random orientations.

In a particular embodiment, conductive pads or patches forming touch sensors may be electrically connected to various integrated circuits (ICs). Here, again, there may be a variety of approaches or techniques to connect one or more ICs. In some embodiments, conductive traces or conductive pads may be routed to an edge of the substrate so that a flexible printed circuit (FPC), for example, or other type of circuit, such as an IC, may be bonded to an area of the substrate. As an example, an FPC or an IC may be connected to a configuration of touch sensors using an anisotropic conductive film (ACF) or paste or other conductive material, although claimed subject matter is not limited in scope in this respect. Furthermore, in some embodiments, an arrangement of touch sensors may be electrically connected, respectively, to one or more drive circuits and one or more sense circuits. As one possible example, without limitation, a sense circuit may be operable to detect changes in capacitance indicative of a touch or near touch and transmit electrical signals representative thereof (e.g., an array of capacitance signal values corresponding to a plurality of touch sensor locations in a configuration of touch sensors) to a processor. However, in some embodiments, a sensing circuit may include the capability to process or in some form pre-process the capacitance signal values so that at least partially processed signal values may be provided for additional processing to another component, such as a processor or the like. In this context, a processor may include, for example, a controller or microcontroller, a digital signal processor, a microprocessor or an application specific integrated circuit (ASIC) containing microprocessor capabilities, to provide several processor examples. Likewise, virtually any number of processors or ICs may be employed, depending, for example, at least in part on the particular application or the particular embodiment. In some embodiments, a drive circuit may apply a voltage or current drive signal (e.g., a periodic signal) to one or more drive lines in the touch sensor panel. A relationship between this drive signal and a signal appearing at touch sensor locations may be a function of capacitive coupling, which may be affected by an object in contact with or in proximity to a touch sensor. Of course, depending at least in part on the particular embodiment, an FPC or other IC to which a touch sensor configuration may electrically connect may also be off module or off chip. As previously suggested and as described in more detail below, for this particular embodiment, signals to or from an FPC or other IC may be routed from the OLED structure via metallized spacers and through a transistor driver structure to reach the FPC or other IC, although claimed subject matter is not limited in scope in this respect.

Returning to FIG. 3, example process flow embodiment 300 for producing an OLED structure embodiment is illustrated. As suggested previously, any or all approaches or techniques applicable to fabrication of an OLED structure embodiment may be encompassed within the scope of claimed subject matter. Therefore, the approaches, techniques or processes described are provide as illustrations and are not intended to limit the scope of claimed subject matter in any way. In the discussion below, reference shall now be made to the OLED structure embodiment shown in FIG. 5. This particular embodiment of an OLED structure may be referred to as an anode-common structure; though, as just mentioned, the scope of claimed subject matter may include any or all variations of OLEDs, including, but not limited to, cathode-common structures, dual-plate OLED (DOD) structures, active or passive matrix OLED structures, or the like.

As previously discussed, an insulation or passivation layer, as shown in FIG. 5, may be included in the fabrication of an OLED structure embodiment. An insulating layer may assist in lessening electrical interferences, such as parasitic interference, for the ITO pads or other electrical components that may be fabricated within the structure embodiment. Likewise, layer 403, as shown, also provides planarization and passivation to form a surface for subsequent deposition, patterning or other fabrication processes, although claimed subject matter is not limited in scope in this respect. At block 315, metallization 501, as illustrated in FIG. 5, may be employed to form an anode for the OLED structure embodiment.

At block 316, a layer of organic light emitting (OLE) material may be applied or deposited over metallization forming anode 501 as shown in FIG. 5. Another metallization layer, in this embodiment forming a cathode 502, as shown in FIG. 5, may be formed over OLED layer 503. FIG. 5 also includes spacer 504 having metallization 505, also illustrated in FIG. 3 by block 318. Techniques for fabrication of a spacer and applying metallization are well-known and understood. Of course, while one spacer is illustrated, more spacers may be employed. Furthermore, in this discussion the fabrication process has been simplified so as to avoid obscuring claimed subject matter. A host of manufacturing processes or operations may be involved in fabrication of a particular OLED structure embodiment, such as to fabricate additional layers, for example, that have not been mentioned specifically here.

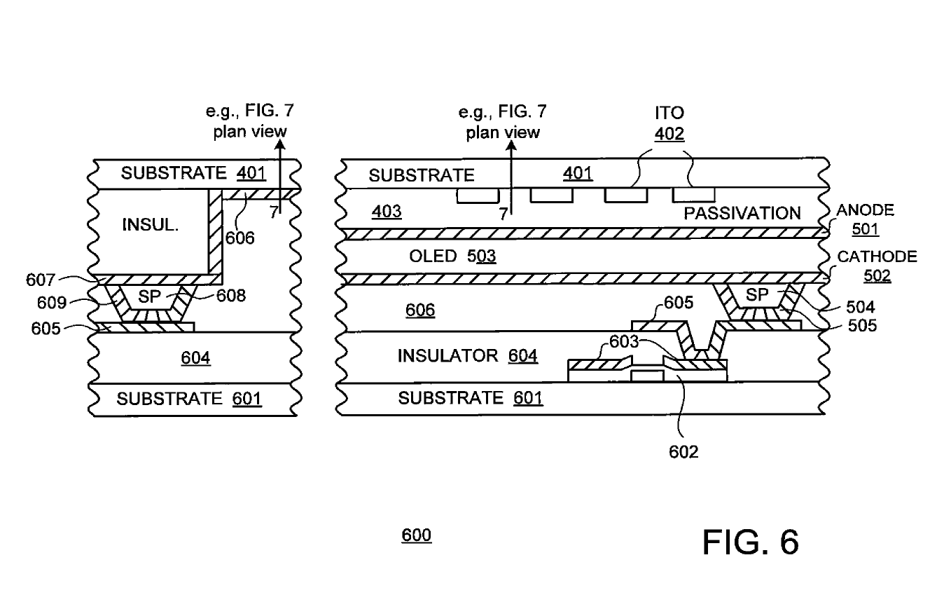

As indicated previously, a transistor driver structure may also be fabricated, although in this embodiment, separate processes may be employed. For example, a substrate may be prepared for fabrication of an array or configuration of driving transistors, for example. Although claimed subject matter is not limited in scope in this respect, the driving transistors may include thin-film transistors (TFTs). Likewise, an insulation layer and metallization layer may be formed after forming the transistors. Fabrication of transistors is a reasonably well understood technology and, therefore, will not be discussed at length here. FIG. 6, however, is a side view of a schematic diagram of one embodiment 600 of a transistor driver structure embodiment integrated with an OLED structure embodiment. Here, FIG. 6 provides an example of a dual-plated OLED structure (DOD). An embodiment of a transistor driver structure is provided therein, including a substrate 601, transistor 602 (including metallization 603), an insulation layer 604 and metallization 605.

In this particular embodiment, the OLED structure embodiment includes a glass substrate 401 with ITO pads or patches 402 formed on one side of the glass substrate, in this embodiment, the side least remote from the OLE material 503 of the OLED structure embodiment. Thus, the glass substrate forms a touch sensitive surface while also providing protection for the OLED structure embodiment. In the particular embodiment, an SITO sensor configuration, formed by ITO pads or patches 602, for example, is employed, with an insulation or passivation layer, as previously described, here 403, insulating and protecting the pads or patches for this particular embodiment.

Of course, claimed subject matter is not limited in this respect. For example, alternately, and as explained previously, a DITO sensor configuration may be employed. In such an embodiment, again, a touch sensor configuration may be formed on one side of a substrate, here a glass substrate, for example, with the other side providing a touch sensitive surface and providing protection for an OLED structure embodiment. However, in yet another embodiment in accordance with claimed subject matter, two substrates may be employed for the touch sensor configuration embodiment within the OLED structure in an SITO configuration. The first substrate of the two substrates may include the outer surface of the module. The second of the two substrates may include on a first of two sides ITO patches or pads with the other side of the substrate facing the display portion of the OLED structure embodiment and the transistor driver structure embodiment. Thus, here, a touch sensor configuration may be sandwiched between two glass substrates with one forming a protective outer cover glass while the other substrate includes ITO pads or patches formed on it. Whereas FIG. 6 illustrates touch sensors on the surface of substrate 401 least remote from OLE material 503, in such an embodiment, the touch sensors may be on the surface of that substrate most remote from the OLE material, if desired, since a protective outer cover glass is also provided that is more remote from the OLE material. Likewise, a DITO touch sensor configuration may be employed that is similarly sandwiched between glass substrates with an insulating layer within the configuration to separate the ITO layers. A host of other arrangements are also possible and claimed subject matter is not intended to be limited to any particular arrangement. It is intended that any and all arrangements or embodiments are within the scope of claimed subject matter.

In the example embodiment shown in FIG. 6, however, an SITO approach one side of a substrate is employed. Here, direct contact occurs between the transistor driver structure embodiment integrated with the OLED structure embodiment. For example, metallization 505 of spacer 504 is in direct and electrical contact with metallization layer 605 so that transistor 602 is able to electrically drive the OLED display. As illustrated in FIG. 6, insulation material may be provided where appropriate to fill gaps in the structure embodiment between the portion of the structure including an array of OLED pixels to form the OLED display and the portion of the structure including an array of transistors to drive the OLED pixels, illustrated, for example, by 606. Here, as illustrated for example by 602, the driving transistors comprise thin-film transistors (TFTs). Furthermore, although not shown explicitly, for this particular embodiment, an OLED or display pixel comprises a structure that includes a red pixel, a green pixel and a blue pixel.

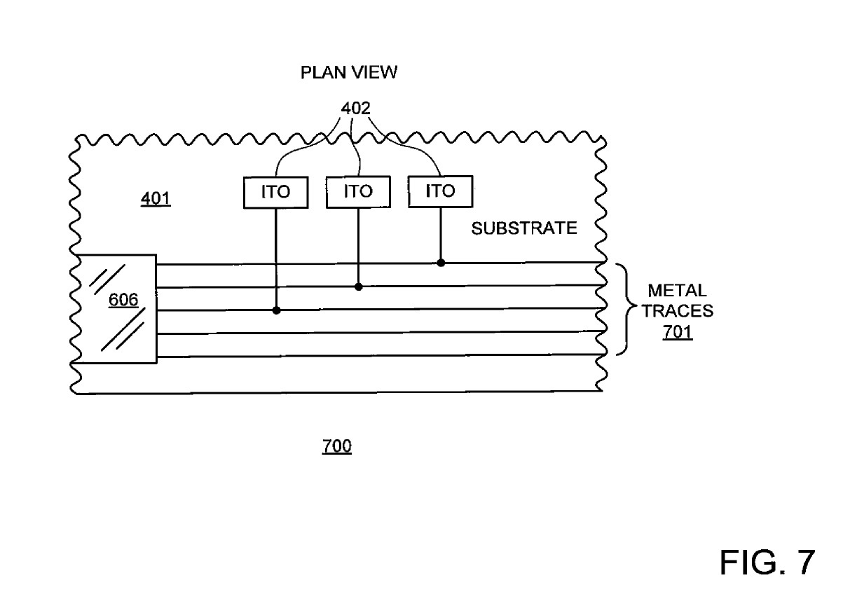

Arrows shown in FIG. 6 correspond to a directional view as shown in FIG. 7. FIG. 7 illustrates a bottom view of substrate 401 including ITO pads 402 and metallization 606. FIG. 6 also illustrates metallization 606 from a side perspective. Here, for example, metallization 606, depending at least in part on the particular embodiment, may route to a flexible printed circuit (FPC) or other IC, as previously described. ITO pads or patches 402 connect to metal traces 701. In other embodiments, metal traces 701 connect to metallization 606 shown in FIGS. 6 and 7. In FIG. 6, as illustrated, metallization 606 also connects to metallized spacer 608. The metallization of the spacer, 609, connects to metallization 605 of the transistor driver structure embodiment. Metallization 605 may electrically contact an FPC on the transistor driver structure embodiment for routing drive and sense lines on and off the module. Therefore, here, routing of signals for the touch sensor embodiment of the OLED structure on or off the module may occur via the transistor driver structure. By routing signals for the touch sensor embodiment down to the transistor driver structure embodiment through metallized spacer 608, a single FPC attached to the transistor driver structure may be employed for processing various signals including signals for the OLED structure or the touch actuated sensor configuration. Therefore, one advantage of this particular embodiment may include reduction of one FPC.

In yet another embodiment, although claimed subject matter is not limited in scope to any particular embodiment, a module may include a first substrate and a second substrate in which passive touch actuated sensors are electrically connected to a component external to the module via a metallization sub-layer of a thin-film transistor layer. For example, the first substrate may have a first layer on a first of two sides that may include passive touch actuated sensors and may have a second layer including an OLE material sandwiched between metallization sub-layers and forming an array of OLED pixels. Likewise, the second substrate on the first of two sides may have a first layer including an array of thin-film transistors. The first and second substrates may be arranged in the module to be mutually adjacent so that at least some of the thin-film transistors of the array of thin-film transistors first are capable of electrically driving at least some of the OLED pixels of the array of OLED pixels formed by the OLE material sandwiched between metallization sub-layers. Furthermore, the passive touch actuated sensors of the first layer on the first substrate may be electrically connected to a component external to the module via a metallization sub-layer, such as, for example, a sub layer of the first layer of the second substrate. Although claimed subject matter is not limited in scope in this respect, the external component may include at least one of an FPC or an IC. Thus, passive touch actuated sensors are capable of being electrically connected via a metallization sub-layer of the thin-film transistor layer, such as on the second substrate, although, again, claimed subject matter is not limited in scope in this respect.

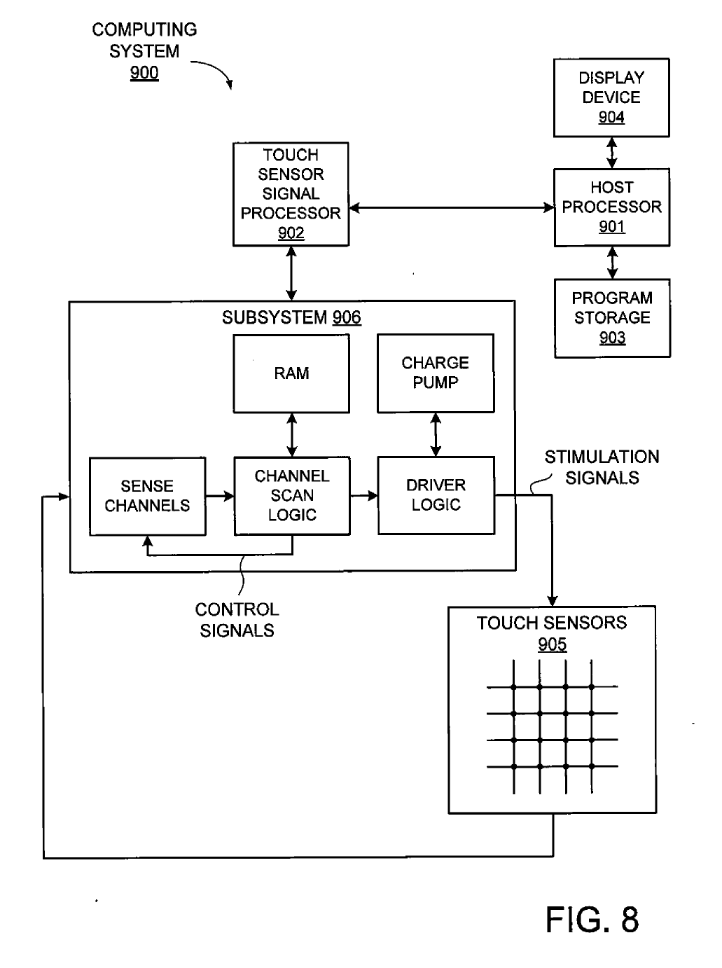

FIG. 8 illustrates a computing system embodiment 900 which may employ a module or IC embodiment formed by integrating a transistor driver structure embodiment with an OLED structure embodiment. For example, display device 904 and touch sensors 905 may be integrated in a module or IC. Computing system 900 may include host processor 901. Host processor 901 may perform functions, which may or may not be related to processing touch sensor signals, and may be connected to program storage 903 and display device 904, for providing a user interface for the device. However, likewise, host processor 901 may be operable to receive electrical signals from touch sensor signal processor 902. Touch sensor processor 902 processes signals from touch sensor configuration subsystem 906. Likewise, touch sensors 905 provide signals to subsystem 906. Therefore, host processor 901 may be capable of performing actions based at least in part on signals from touch sensor signal processor 902 that may include, but are not limited to, moving an object, such as a cursor or pointer, scrolling or panning, adjusting control settings, opening a file or document, viewing a menu, making a selection, executing instructions, operating a peripheral device connected to the host device, answering a telephone call, placing a telephone call, terminating a telephone call, changing volume or other audio settings, storing signal information related to telephone communications such as addresses, frequently dialed numbers, received calls, missed calls, logging onto a computer, a computing device, or a network, permitting authorized individuals access to restricted areas of the computer, computing device, or network, loading a user profile associated with a user's preferred arrangement of a computer or computing device desktop, permitting access to web content, launching a particular program, encrypting or decoding a message, or the like.

Likewise, a computing device or system, such as embodiment 900, by way of example, may include firmware. Firmware may also be propagated within any transport medium for use by or in connection with an instruction execution system, apparatus, or device, such as a computer-based system, processor-containing system, or other system that is able to access instructions from an instruction execution system, apparatus, or device and execute the instructions. In this context, a “transport medium” may be any medium that is able to communicate, propagate or transport a computer or computing program for use by or in connection with the instruction execution system, apparatus, or device. The transport readable medium may include, but is not limited to, an electronic, magnetic, optical, electromagnetic or infrared wired or wireless propagation medium.

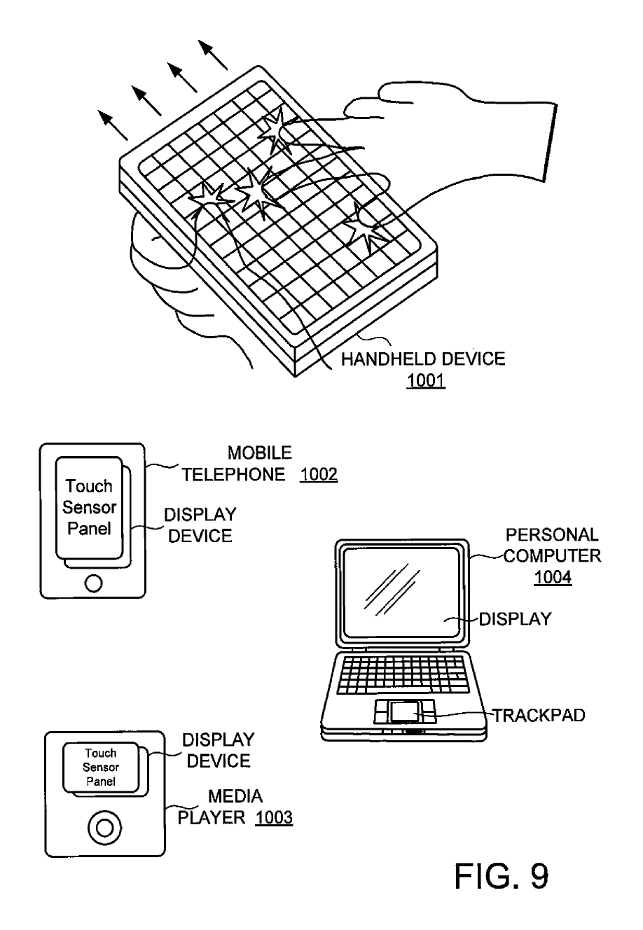

FIG. 9 is a schematic diagram illustrating various devices which may include or employ a module or IC embodiment formed by integrating a transistor driver structure embodiment with an OLED structure embodiment. For example, hand held device embodiments 1001, 1002 or 1003 may include a module or IC embodiment formed by integrating a transistor driver structure with an OLED structure embodiment that includes a touch sensor configuration embodiment and may be capable of transmitting signals to or receiving signals from various other devices, such as via a wired or wireless communication interface. Embodiment 1001 corresponds to the embodiment previously illustrated by FIG. 1, for example. Likewise, a mobile telephone embodiment 1002 is depicted, as is a digital media player embodiment 1003 and a personal computer 1004. These devices, therefore, may have improved overall functionality or reliability, may be manufactured at a lower cost or with higher yield, or may exhibit characteristics which consumers may find desirable, such as being smaller, lighter, thinner, or the like.

While there are numerous particular advantages to this particular exemplary embodiment, one advantage may be that the previously described embodiments may result in a better yield, and potentially lower costs, during the manufacturing process. Similarly, embodiments in accordance with claimed subject matter may allow devices to be smaller, lighter, or thinner, which consumers generally find desirable. For example, after fabrication of a module, such as one of the previously described embodiments, the outer glass substrates may be thinned, such as by chemical polishing, mechanical polishing, other processes, or by a combination of a variety of processes.

Although embodiments have been fully described with reference to the accompanying drawings, it is to be noted that various changes or modifications may become apparent to those skilled in the art. Such changes or modifications are to be understood as being included within the scope of claimed subject matter.

What is claimed is:

1. A device comprising:
an OLED structure integrated with a transistor driver structure;
wherein the OLED structure further includes a passive touch actuated sensor configuration; and
wherein metallization of the transistor driver structure facilitates routing of touch sensor signals to the transistor driver structure.

2. The device of claim 1, wherein the OLED structure includes a spacer having metallization thereon to connect the passive touch actuated sensor configuration to the metallization of transistor driver structure.

3. The device of claim 2, wherein the OLED structure includes additional spacers at least some of which have metallization thereon that connect to the passive touch actuated sensor configuration.

4. The device of claim 2, wherein the metallization of the transistor driver structure comprises a configuration to route the touch sensor signals to a flexible printed circuit.

5. The device of claim 2, wherein the passive touch actuated sensor configuration is capable of connecting to drive and sense lines via the routing provided by the metallization of the transistor driver structure.

6. The device of claim 1, wherein the passive touch actuated sensor configuration comprises a capacitive touch actuated sensor configuration.

7. The device of claim 6, wherein the touch sensors of the capacitive touch actuated sensor configuration comprise Indium Tin Oxide (ITO) pads.

8. The device of claim 7, wherein the touch actuated sensor configuration includes single-sided Indium Tin Oxide (SITO).

9. The device of claim 1, wherein the device comprises a dual-plate OLED display (DOD).

10. The device of claim 9, wherein the glass substrate of the DOD comprises a thinned glass substrate.

11. The device of claim 10, wherein the thinned glass substrate was thinned by applying at least one of the following glass thinning techniques: glass etching; glass chemical polishing; glass mechanical polishing: or any combination thereof.

12. The device of claim 9, wherein the DOD is a component of a hand-held device.

13. A method comprising:
fabricating a passive touch actuated sensor configuration integrated with an OLED structure on one side of another substrate and a transistor driver structure on one side of another substrate;
combining the transistor driver structure and the passive touch actuated sensor configuration with an OLED structure into a single module so that metallization of the transistor driver structure facilitates routing of touch sensor signals for further processing.

14. The method of claim 13, wherein the passive touch actuated sensor configuration integrated with an OLED structure and the transistor driver structure are fabricated by separate processes.

15. The method of claim 14, wherein the processes for fabricating the configuration occur at temperatures or pressures that are different from the processes for fabricating the structure.

16. The method of claim 14, wherein the combining the transistor driver structure and the passive touch actuated sensor configuration with an OLED structure into a single module comprises applying a process to cure the combination of the structures.

17. The method of claim 13, wherein at least one of the structure substrates comprises glass; and further comprising: thinning the glass substrate.

18. The method of claim 17, wherein the thinning the glass substrate comprises applying at least one of the following: glass etching; glass chemical polishing; glass mechanical polishing: or any combination thereof.

19. A module comprising:
a first substrate and a second substrate;
wherein the first substrate on a first of two sides includes a first layer comprising passive touch actuated sensors and a second layer comprising an OLE material sandwiched between metallization sub-layers and forming an array of OLED pixels, and the second substrate on the first of two sides including a first layer comprising an array of thin-film transistors;
wherein the first and second substrates being mutually adjacent and arranged so that at least some of the thin-film transistors of the array of thin-film transistors first are capable of electrically driving at least some of the OLED pixels of the array of OLED pixels formed by the OLE material sandwiched between metallization sub-layers; and
wherein the passive touch actuated sensors of the first layer on the first substrate being electrically connected to a component external to the module via a metallization sub-layer of the first layer of the second substrate.

20. The module of claim 19, wherein the external component comprises at least one of an FPC or an IC.

21. The module of claim 19, wherein the passive touch actuated sensors are capable of being electrically connected to drive and sense lines via the metallization sub-layer of the thin-film transistor layer on the second substrate.

22. The module of claim 19, wherein the two substrates are oriented so that the second side of the first substrate is most remote from the second side of the second substrate.

23. A device formed by the following method, the method comprising:
fabricating a passive touch actuated sensor configuration integrated with an OLED structure on one side of another substrate and a transistor driver structure on one side of another substrate;
combining the transistor driver structure and the passive touch actuated sensor configuration with an OLED structure into a single module so that metallization of the transistor driver structure facilitates routing of touch sensor signals for further processing.

24. The device of claim 23, wherein the fabricating a touch actuated sensor configuration with an OLED structure comprises fabricating the touch actuated sensor configuration by a process that is separate from the process for fabricating the transistor driver structure.

25. The device of claim 24, wherein the fabricating the touch actuated sensor configuration by a process that is separate from the process for fabricating the transistor driver structures comprises employing processes that occur at temperatures or pressures for the configuration that are different from the processes for the structure.

26. The device of claim 23, wherein at least one of the substrates comprises a glass substrate; and wherein the method for forming the device further includes: thinning the at least one of the substrates that comprises a glass substrate.
